(19) United States
(12) Patent Application Publication
(10) Pub. No.: US 2012/0321431 A1
(43) Pub. Date: Dec. 20, 2012

(54) STACKABLE CARTRIDGE HOLDING TRAY SYSTEM

(75) Inventors: Shaun Riedesel, Madison, SD (US); Randy Derby, Estelline, SD (US)

(73) Assignee: FALCON PLASTICS, INC., Brookings, SD (US)

(21) Appl. No.: 13/523,584

(22) Filed: Jun. 14, 2012

Related U.S. Application Data
(60) Provisional application No. 61/460,761, filed on Jun. 14, 2011.

(51) Int. Cl. B65D 21/032; B65G 57/02

(52) U.S. Cl. 414/802; 206/509

(57) ABSTRACT

A stackable tray device and system is constructed for retaining substantially cylindrical objects, such as cylindrical cartridges of ammunition, and generally comprises upper and lower sections that have perimeter dimensions of unequal value, which provide for a means of stacking or nesting two such configured trays in adjacent arrangement to each other in a stable manner, the upper section of the stackable tray being configured with a plurality of cells, each sized to receive a substantially cylindrical member, and the cell being structured to retain the cylindrical member in a substantially stable upright, or vertical, position within the cell.

### CROSS-REFERENCE TO RELATED APPLICATIONS

This application is a non-provisional application of, and claims priority to, U.S. provisional application Ser. No. 61/460,761, filed Jun. 14, 2011, the contents of which are incorporated herein in their entirety.

### BACKGROUND OF THE INVENTION

1. Field of the Invention

This invention relates to ammunition storage devices, and specifically relates to a stackable tray device and system for holding cartridges or similar cylindrical members.

2. Description of Related Art

Tray-type devices for holding ammunition cartridges are known, as exemplified in U.S. Pat. No. 5,052,549 and U.S. Pat. No. 3,813,987. Such tray devices are typically provided in the form of loading blocks which are configured to hold an empty cartridge in an upright position for refilling with powder. The configuration of conventional trays for holding ammunition cartridges is generally not directed to enabling multiple numbers of empty trays (i.e., not filled with cartridges) to be nested in a manner that facilitates storage and transporting of the trays. Consequently, conventional trays are costly to transport and store.

It would be advantageous in the art to provide a stackable tray device and system of stackable trays that are configured to retain and hold a plurality of ammunition cartridges in a vertically stacked arrangement for facilitating the retention, handling and transport of ammunition cartridges, as well as to reduce the traditional costs of transporting and storing the unfilled trays.

### BRIEF SUMMARY OF THE INVENTION

In accordance with the present disclosure, a stackable tray device and system are described which are particularly suitable for receiving and retaining cylindrical objects of a type exemplified by cylindrical cartridges of ammunition. The stackable tray device is particularly configured to not only provide means for holding and storing cylindrical objects in a stacked array for easy storage, handling and transport, but also provides means for improving the inherent costs of storing and transporting a plurality of stackable tray devices.

In one aspect of the invention, a stackable tray is structured with conjoined upper and lower sections that have perimeter dimensions of unequal value, which provide means for stacking or nesting two such configured trays in adjacent arrangement to each other in a stable manner. The upper section of the stackable tray is further configured with a plurality of cells, each sized to receive a cylindrical member, such as a cartridge, the cell being structured to retain the cartridge in a substantially stable upright, or vertical, position within the cell.

In a further aspect of the invention, each cell may be structured to accommodate cylindrical objects that have varying circumferential dimension. In particular, each cell may be structured to accommodate cylindrical objects of varying circumferential dimension, or cells of differing configuration may be provided which each accommodate a cylindrical object of a selected circumferential dimension.

In a further aspect of the invention, each cell may be structured with inwardly extending rib supports that each provide an inward edge which is oriented toward the center of the cell. The inward edge may be configured with an angled surface, relative to a plane formed through the center axis of the cell, which generally conforms the inward edge of the rib to the curved outer circumference of a cylindrical object positioned in the cell.

In a further aspect of the invention, the upper section of the stackable tray is formed with a plurality of openings, with one opening associated with each cell. The opening of each cell may preferably be centered relative to a circumferential boundary defined by the inward edges of the ribs associated with the individual cell. The opening of the cell provides means for accommodating a portion of the cylindrical object that is positioned vertically in the cell. That portion of the cylindrical object extending through the opening thus extends into a space formed by the perimeter wall of the lower section of the stackable tray.

The configuration of the stackable tray is selected to maximize the structural strength and stability of each tray to improve handling, transportation and storage of the trays over conventional trays.

The fundamental features of the disclosure having been enumerated, further details of various embodiments of the invention are described hereinafter. It should be noted that the scope of the disclosure is not limited in its applicability to the specific details of construction illustrated and described herein, or to the arrangements of the components set forth in the following description or illustrations. The disclosure is capable of many other embodiments and implementations, and is capable of being practiced and carried out in various ways.

### BRIEF DESCRIPTION OF THE SEVERAL VIEWS OF THE DRAWINGS

In the drawings, which currently illustrate an exemplary best mode for carrying out the invention:

FIG. 1 is an isometric view of a stackable tray device in accordance with the disclosure, the open end of the cells being oriented upwardly;

FIG. 2 is an isometric view of the stackable tray device shown in FIG. 1, rotated 180° about a longitudinal axis of the tray device;

FIG. 3 is an isometric view of the stackable tray device shown in FIG. 2, rotated 90° about a longitudinal axis of the tray device;

FIG. 4 is a plan view of the stackable tray device shown in FIG. 1 depicting the open end of the cells;

FIG. 5 is a plan view of the stackable tray device shown in FIG. 4, rotated 180° about a longitudinal axis, to depict a bottom section of the cells;

FIG. 6 is a side view in elevation of two stackable tray devices positioned for nestable stacking together;

FIG. 7 is a side view in elevation of a single stackable tray device, with configurational elements shown in phantom;

FIG. 8 is a plan view of an alternative embodiment of a stackable tray device in accordance with the disclosure;

FIG. 9 is an isometric view of an alternative embodiment of the stackable tray device;

FIG. 10 is a plan view of the stackable tray shown in FIG. 9;

FIG. 11 is an enlarged section of the stackable tray shown in FIG. 10;

FIG. 12 is a view in cross section of the stackable tray shown in FIG. 9, taken at line 12-12;

FIG. 13 is a view in cross section of the stackable tray shown in FIG. 9, taken at line 13-13;

FIG. 14 is a view in lateral cross section illustrating two empty stacked trays;

FIG. 15 is a longitudinal view in cross section of a stack of four empty stackable trays;

FIG. 16 is an isometric view of a tray that has cylindrical cartridges positioned in each cell of the stackable tray;

FIG. 17 is a plan view of the filled tray shown in FIG. 16;

FIG. 18 is a view in longitudinal cross section of the filled tray shown in FIG. 17, taken at line 18-18; and

FIG. 19 is a view in lateral cross section of the filled tray shown in FIG. 17, taken at line 19-19.

### DETAILED DESCRIPTION OF THE INVENTION

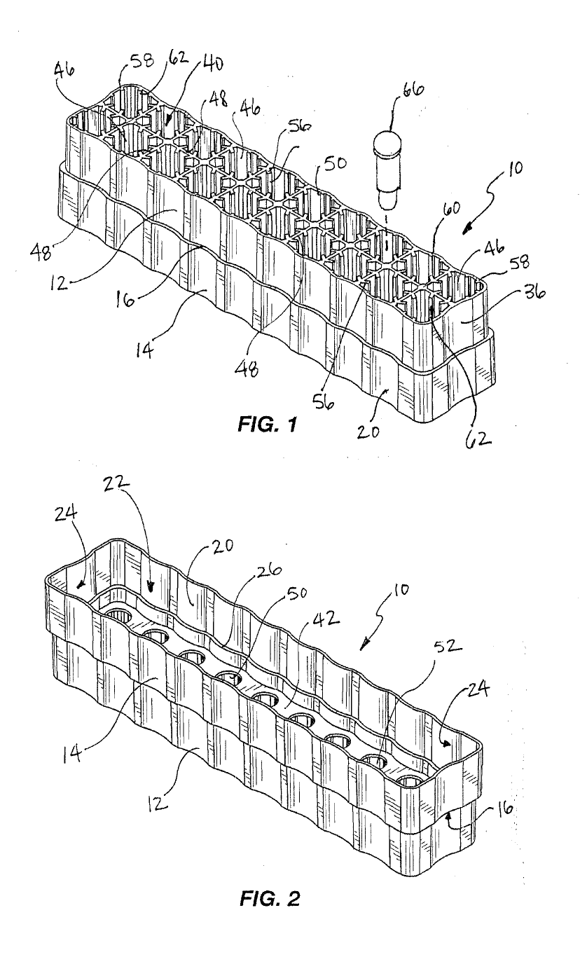

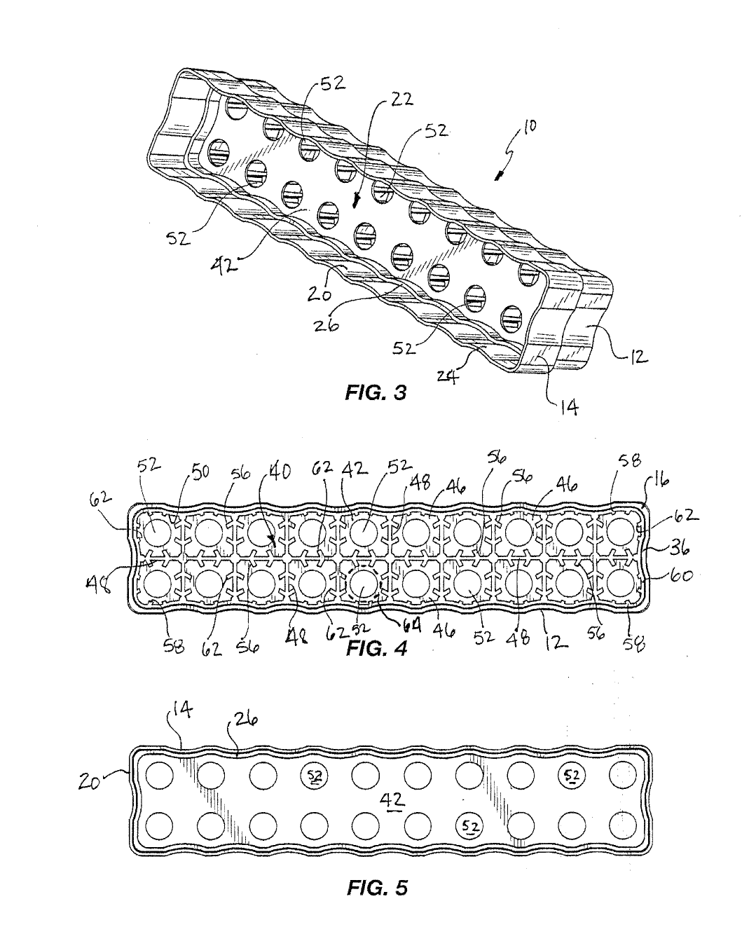

With reference to the drawings, and in particular to FIGS. 1 through 5, a stackable cartridge holding tray system embodying the principles and concepts of the disclosed subject matter will be described.

The disclosure generally relates to a stackable tray device 10 which is structured to facilitate a nested stacking arrangement as described more fully hereinafter. The stackable tray device 10 is configured to enable a nested stacking arrangement of multiple numbers of stackable tray devices, which facilitates storage and transport of many more tray devices than is capable with conventional, non-nestable tray devices, thereby resulting in a realization of reduced storage and transport costs over conventional tray devices.

The stackable tray device 10 generally includes an upper section 12 and a lower section 14 having perimeter dimensions which are unequal. In the particular embodiment of the stackable tray device 10 depicted in FIG. 1, the upper section 12 has a perimeter dimension, defined by the circumference about the outer surface or perimeter wall of the section, which is less than the perimeter dimension of the lower section 14. In alternative embodiments, the upper section 12 may have a perimeter dimension that is greater than the perimeter dimension of the lower section 14.

The differential in perimeter dimensions of the upper section 12 and lower section results in an outwardly extending shoulder 16 being defined between the upper section 12 and the lower section 14, as best seen in FIG. 1.

As best shown in FIGS. 2, 3 and 7, the lower section 14 of the stackable tray device 10 may be configured such that the perimeter wall 20 of the lower section 14 defines an interior space 22 extending between an internal surface 24 of the perimeter wall 20. A corresponding inner ledge 26 is disposed substantially along the internal surface 24 of the perimeter wall 20 of the lower section 14 and extends inwardly from the perimeter wall 20. The inner ledge 26 may, in some embodiments, comprise a surface that is defined by the shoulder 16 formed between the upper section 12 and lower section 14. In other embodiments, the inner ledge 26 may be a structure defined by other than the shoulder 16.

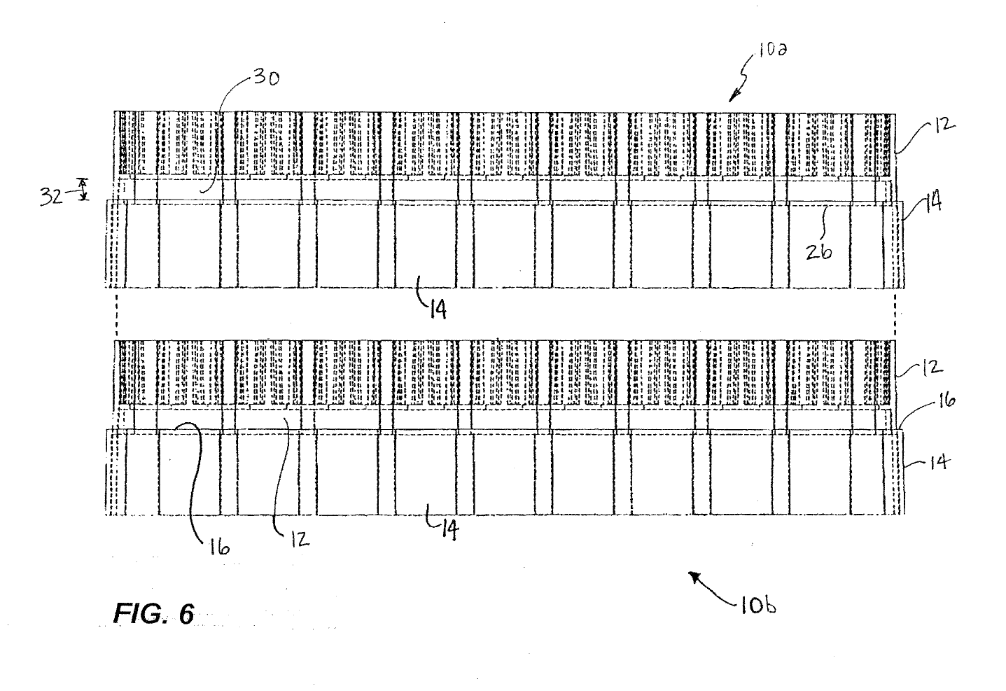

As best illustrated in FIG. 6, the general configuration of the stackable tray device 10 thus far described provides structural means for enabling the nesting of one stackable tray device 10a with another stackable tray device 10b, whereby the shoulder 16 of one stackable tray device 10b provides a contact surface against which the inner ledge 26 of another stackable tray device 10a comes into registration when the two stackable tray devices 10a, 10b are placed in adjacent, nested position. It can be appreciated from the depiction of FIG. 6 that when two such stackable tray devices 10a, 10b are brought into registration with one another, a space 30 having a selected height dimension 32 may be provided to accommodate substantially cylindrical objects stored in the stackable tray devices 10, as described more fully below.

It is to be noted at this point that the stackable tray device 10 depicted in the drawings is generally formed with a rectangular shape having opposing long sides and opposing short ends. However, the stackable tray device 10 may be configured and dimensioned in many different ways, such as a square arrangement having side walls that are all of substantially equal length. Alternatively, the stackable tray device 10 may be configured, for example, with a circular perimeter wall.

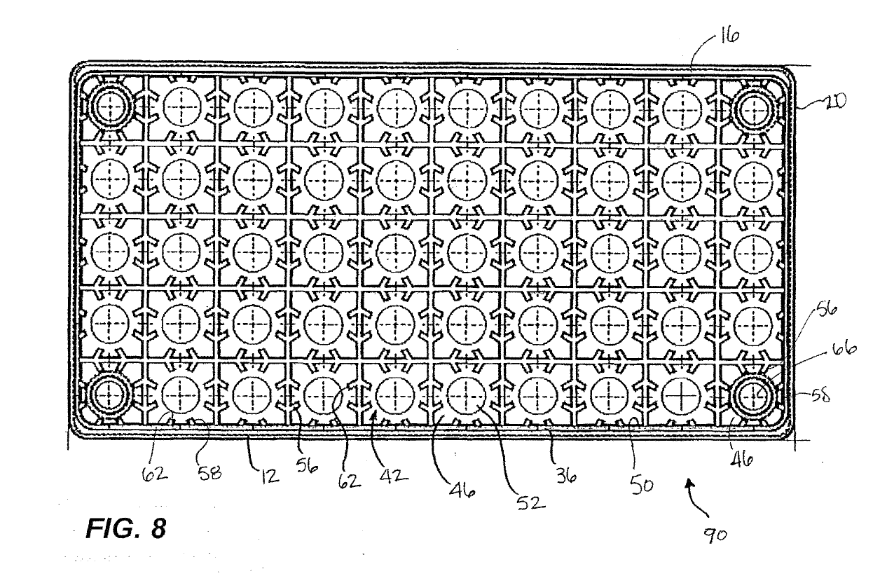

It should also be noted that the perimeter wall 36 of the upper section 12 and the perimeter wall 20 of the lower section 14 may, as depicted in the drawings, be a continuous wall with a continuous or uninterrupted surface. Alternatively, the perimeter walls 20, 36 may be formed with discontinuities. Also, the perimeter walls 20, 36 are depicted in the drawing figures as having an ornamental scalloped configuration, but the perimeter walls 20, 36 may be planar, as depicted in FIG. 8, or any other configuration. The particular configuration of the walls may be selected to provide improved strength and stackability of the trays to improve filling, handling and storage of the trays.

Referring again to FIGS. 1 through 5, the perimeter wall 36 of the upper section 12 of the stackable tray device 10 defines an interior space 40 that is further defined by a bottom wall 42 that transects the upper section 12. The interior space 40 of the upper section 12 is further divided into a plurality of cells 46, each cell 46 being defined by wall sections 48 that extend from an inner surface 50 of the perimeter wall 36 toward the interior space 40. As in the embodiment depicted in FIGS. 1 through 5, the wall sections 48 may converge and join to form distinct cells 46 having a continuous wall defined by the wall sections 48 and at least one perimeter wall 36. Alternatively, the walls 48 may be discontinuous or have discontinuities.

Each cell 46 of the plurality of cells is further defined by the bottom wall 42 of the upper section 12. As depicted in FIGS. 2, 3, 4 and 5, the bottom wall 42 may be formed with openings 52 that extend through the bottom wall 42. Each opening 52 is positioned to be generally centrally located relative a corresponding cell 46 as described further below.

Each cell 46 may further be configured with rib members 56 that extend outwardly from the wall sections 48 toward the center of each cell 46. Rib members 58 may also be formed to extend from the inner surface 50 of the perimeter wall 36 toward the center of the respective cell 46. The rib members 56, 58 may generally extend in axial length from at or near the bottom wall 42 toward the top edge 60 of the wall sections 48 or perimeter wall 36. The rib members 56, 58 can also extend an axial length that is less than the length defined between the bottom wall 42 and the top edge 60 of the perimeter wall 36. As used herein, the terms “axial” or “axis” are meant to be defined by a central axis extending through each cell in a direction extending from the upper section 12 through the lower section 14.

The rib members 56, 58 may extend various radial lengths, as measured from the wall section 48 or inner surface 50 of the perimeter wall 36 toward the center axis of a given cell 46, as best seen in FIG. 4. A variance in the radial lengths of the rib members 56, 58 may provide for the accommodation of cylindrical objects of varying circumference within a single stackable tray device 10. The rib members 56, 58 may also be slightly flexible in a manner that allows the rib members 56, 58 to move relative to the wall section 48 or inner surface 50 from which it extends to thereby accommodate cylindrical objects of larger circumference.

The number of rib members 56, 58 that are provided to extend from the wall sections 48 or inner surface 50, defining any given cell 46, may also vary.

In a first aspect or embodiment shown in FIGS. 1 and 4, a pair of rib members 56, 58 may extend inwardly from each wall section 48 or from the inner surface 50 of the perimeter wall 36. The rib members 56, 58 may extend from the wall section 48 or inner surface 50 at a perpendicular angle to the wall section 48 or inner surface 50. More preferably, the rib members 56, 58 may extend from the wall section 48 or inner surface 50 at an angle thereto, as depicted in FIGS. 1, 4 and 8, to better accommodate the positioning of cylindrical objects in the cell 46.

Further, each rib member 56, 58 has an inner edge 62 oriented toward the center of the cell 46 with which it is associated. The inner edge 62 of the rib members 56, 58 may be oriented substantially parallel to the wall section 48 or inner surface 50 from which the rib member 56, 58 extends.

Alternatively, as depicted in FIGS. 1, 4 and 8, the inner edge 62 of some or all of the rib members 56, 58 may be oriented at a non-parallel angle relative to the wall section 48 or inner surface 50 from which the rib member 56, 58 extends. The angled inner edge 62 of the rib members 56, 58 enables the inner edge 62 to accommodate or conform to the curvature of a cylindrical object placed in the cell 46, as best viewed in FIG. 8.

As depicted by a phantom line in FIG. 4, the inner edges 62 of each cell 46 may define a holding perimeter 64 within which a cylindrical object is held when positioned in a cell 46. The opening 52 formed in the bottom wall 42 of the upper section 12 is oriented to be centered within the defined holding perimeter 64, and the opening 52, as depicted in FIG. 4, may be smaller than the area dimension of the holding perimeter 64. Alternatively, the opening 52 may be of the same area dimension of the holding perimeter 64. The holding perimeter 64 defines an area that is smaller than the area of the cell 46 such that the cylindrical object is held in a position away from the inner walls 48 of the tray 10.

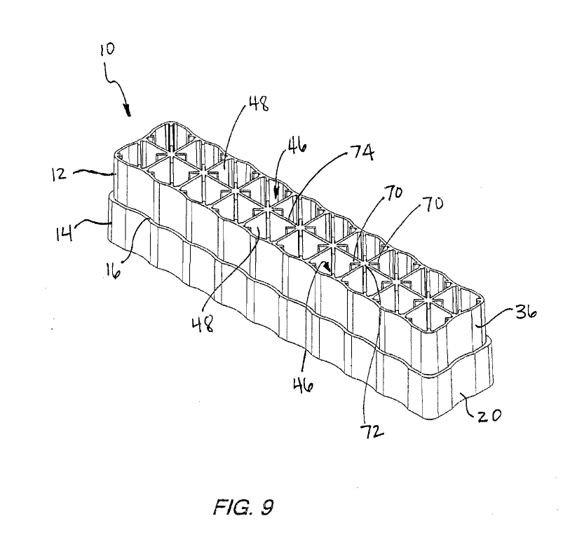

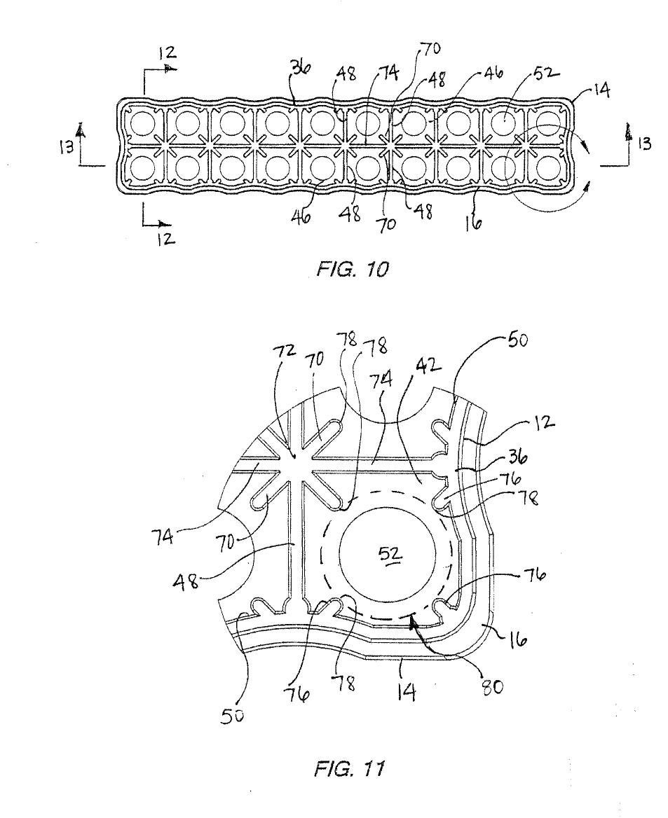

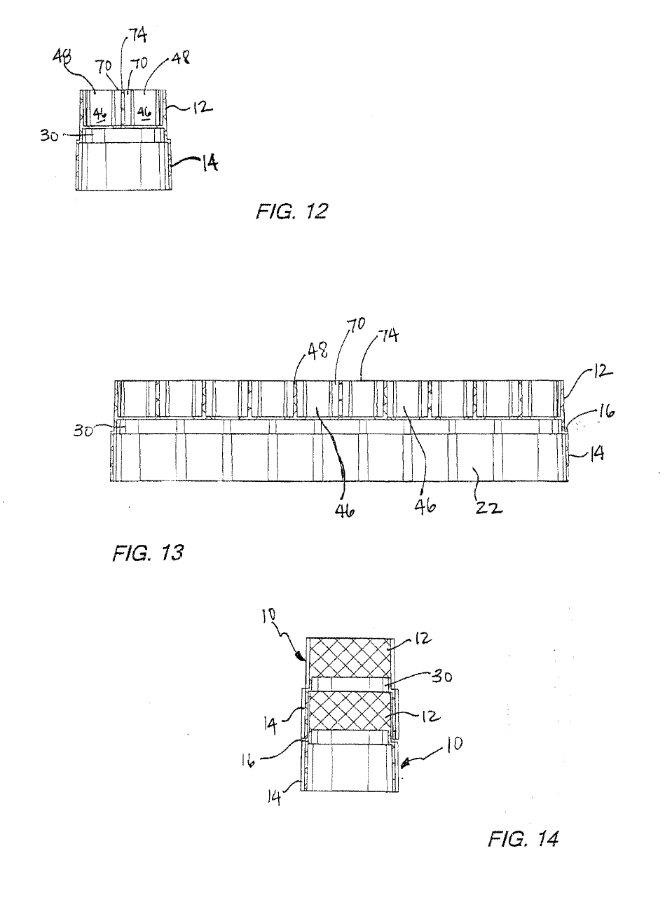

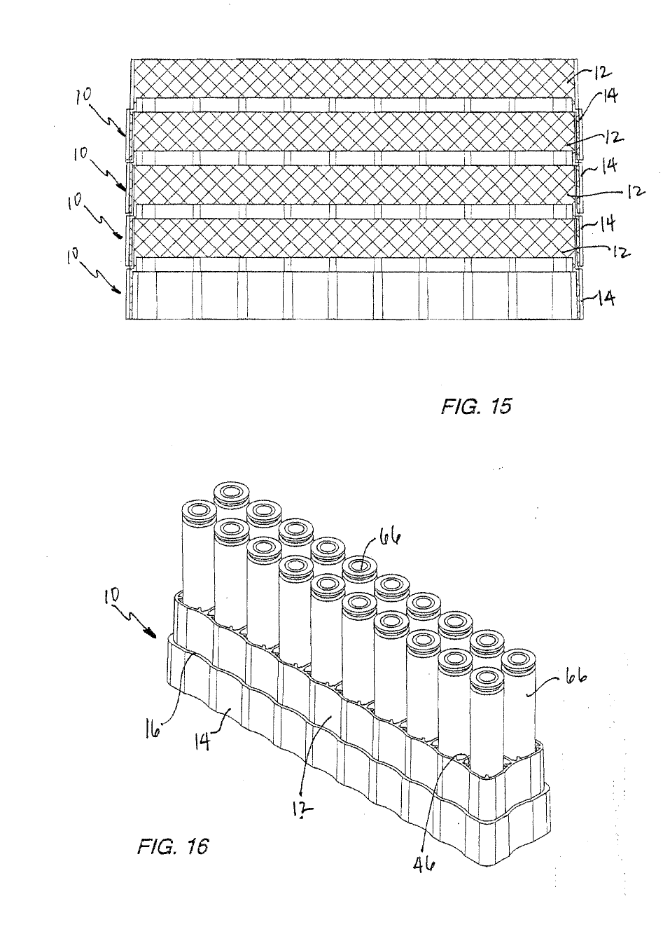

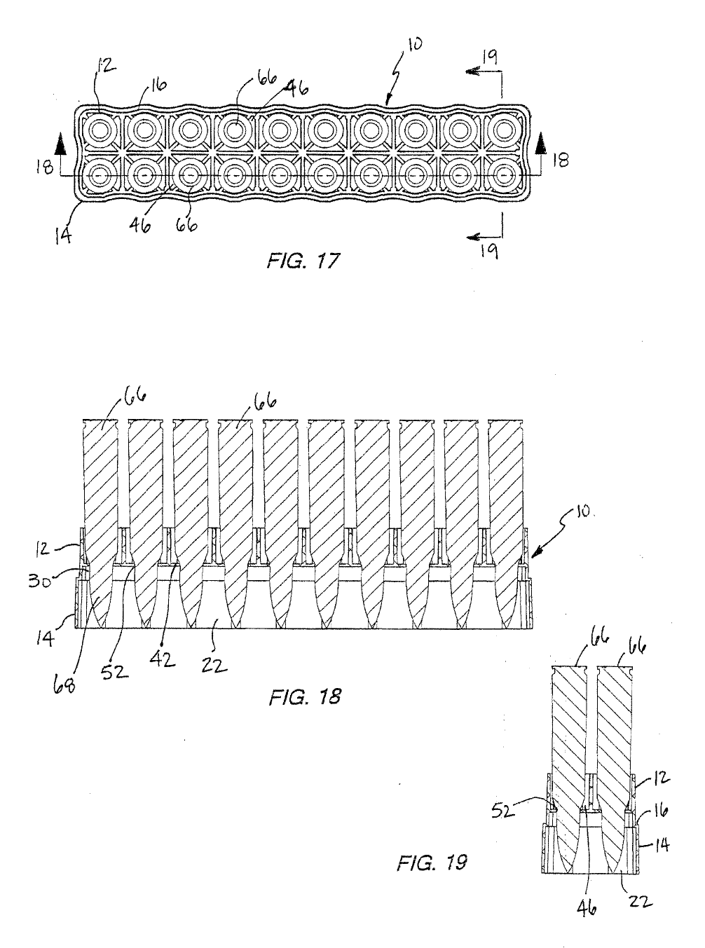

In a further aspect or embodiment shown in FIGS. 9-19, the stackable tray 10 may be formed with rib members 70 that extend from a point of intersection 72 between wall sections 48 that extend inwardly from the inner surface 50 of the perimeter wall 36 and a longitudinal wall 74. As best seen in FIGS. 10 and 11, each cell 46 of the upper section 12 of the tray 10 has at least one rib member 70 that extends from the wall sections 48 and at least one rib member 76 that extends from the inner surface 50 of the perimeter wall 36. As shown in FIGS. 9-11, each cell 46 may have four rib members 70, 76 extending radially inwardly toward the center of the cell 46. The inner edges 78 of the rib members may define a holding perimeter 80, as depicted by phantom line, and the opening 52 through the bottom wall 42 of the upper section 12 is preferably centered within the holding perimeter 80. The opening 52 may be of a smaller area dimension than the area of the holding perimeter 80, as shown, or may be of a more equal area.

As depicted in FIGS. 1 and 16, the cells 46 are generally configured to receive and support a cylindrical object, such as a cartridge 66 of ammunition. The stackable tray device 10 may be used to retain other substantially cylindrical objects, however. As used herein, “substantially cylindrical” or “generally cylindrical” includes items that are cylindrical, as well as items that may be more ovate in shape when viewed in lateral cross section or octagonal in shape when viewed in lateral cross section, or having shapes of similar construction.

It will be understood that the depth of the cells 46, as measured from the top edge 60 of the perimeter wall 36 or wall sections 48 to the bottom wall 42, is suitably sized to receive a substantial length of the substantially cylindrical object placed in the cell 46. When ammunition cartridges 66 are stored in the cells 46, as illustrated in FIGS. 16-19, the nose portion 68 of the cartridge 66 may be received through the opening 52 formed in the bottom wall 42 of the cell 46 to aid in stably securing the cartridge 66 within the cell 46. The opening 52 may or may not be sized to contact that portion of the cylindrical object that extends through the opening 52.

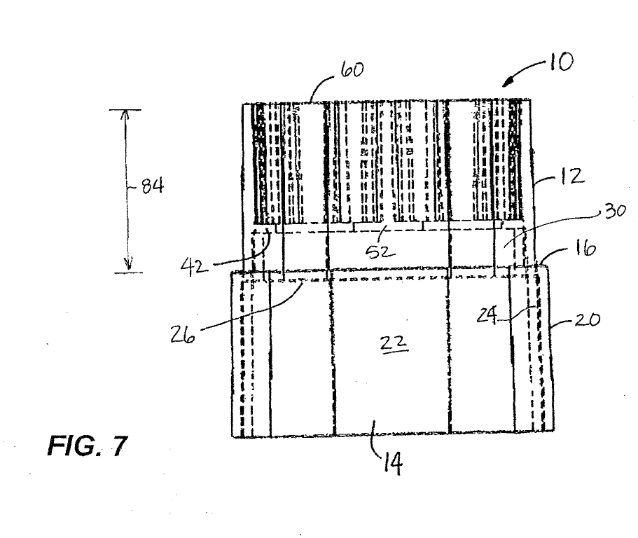

It will also be appreciated that in certain embodiments of the invention, as illustrated in FIGS. 6 and 7, the upper section 12 of the stackable tray 10 may have a selected height 84, as depicted in FIG. 6, which accommodates a length dimension of the cylindrical object (e.g., cartridge 66), such that when two stackable tray devices 10a, 10b and nested together, the end of the cylindrical object, or cartridge 66, may extend into the space 30 (FIG. 6) formed therebetween in a manner that best facilitates the nested stacking of adjacent stackable tray devices 10a, 10b in a system comprising a plurality of nested stackable tray devices.

In other aspects of the invention, and depending on the length of the cylindrical object being received in the stackable trays, the trays may not be capable of being nested when filled with cylindrical objects. An example of this arrangement is depicted in FIGS. 16-19, which illustrate a tray 10 having a plurality of cells 46, each cell being filled with an ammunition cartridge 66. Due to the length of the cartridges 66, the filled trays 10 could not be nested, but may be stackable one atop another depending on how far the cylindrical objects extend into the interior space 22 of the lower section 14.

The configuration and construction of the trays 10, in any aspect of the invention, however, are structured to be stackable in a nested arrangement for storage and transportation, as shown in FIGS. 6, 14 and 15, which illustrate multiple numbers of trays 10, stacked one upon another in nested arrangement.

FIG. 8 depicts an alternative embodiment of the stackable tray device 10 in which like parts are indicated with the same reference numerals used in the description of previous embodiments. In the embodiment depicted in FIG. 8, a stackable tray device 10 of larger dimensions is shown, in which a plurality of cells 46 are provided in a plurality of rows. Again, the embodiment shown in FIG. 8 best illustrates how the cylindrical object, or cartridge 66, is accommodated by the rib members 56, 58 of the cell 46 in which the object is positioned.

Significantly, the stackable character of the stackable tray devices, and the ability to nest the trays when stacked, may provide several advantages. The nested stacking character helps to orient the stackable tray devices when being packaged in bulk and transported prior to filling with cylindrical objects, such as cartridges. The configuration of the stackable tray devices assumes a relatively smaller amount of space in the packaging for each tray. The stacking character also orients the trays in the bulk packaging process, which can reduce any distortion of the tray parts during shipping. Further, the stacked relationships of the trays can provide support for portions of the perimeter wall by adjacent stacked trays to help minimize warpage and distortion of the trays after forming or molding, and during shipping. Also, the stacking can help maintain the orientation of the trays during unloading of the trays from the bulk packaging after shipping, and facilitates the loading of the trays into automated cartridge loading lines.

Further, the rib members of the stackable tray devices beneficially eliminate the use of double walls, such as in previous designs where a tray employs an outer perimeter wall and a plurality of cylindrical walls for forming cartridge-holding cavities, and thus avoids gaps between the walls while simplifying the tooling of the mold. The use of the rib members also reduces the amount of material needed for forming the tray as compared to designs which use the plurality of cylindrical and doubled walls.

With respect to the above descriptions, it is to be appreciated that the optimum dimensional relationships for the parts of the disclosed embodiments and implementations include variations in size, materials, shape, form, function and manner of operation, assembly and use. Therefore, the foregoing is considered as illustrative only of the principles of the disclosure. Further, since numerous modifications and changes will readily occur based on the disclosure herein, it is not desired to limit the disclosed subject matter to the exact construction and operation shown and described, and, accordingly, all suitable modifications and equivalents may be resorted to that fall within the scope of the claims.

What is claimed is:

1. A stackable tray device for holding a plurality of generally cylindrical objects in an upright orientation, the holding tray comprising:
an upper section having a perimeter wall with a perimeter dimension and defining an interior space;
a lower section having a perimeter wall with a perimeter dimension, the perimeter dimension of the lower section being unequal to the perimeter dimension of the upper section;
a shoulder defined by and between the differential perimeter dimensions of said upper section and said lower section;
an inner ledge formed in said lower section in an interior space formed by said perimeter wall of said lower section; and
a plurality of cells formed within said interior space of said upper section, each cell having a center and having at least one rib member extending inwardly toward said center of said cell to retain a generally cylindrical object within said cell.

2. The stackable tray device of claim 1, wherein said shoulder and said inner ledge define opposing and spaced apart surfaces.

3. The stackable tray device of claim 1, wherein said perimeter dimension of said upper section is less than said perimeter dimension of said lower section.

4. The stackable tray device of claim 1, further comprising a bottom wall section positioned to transect said upper section.

5. The stackable tray device of claim 4, wherein said bottom wall is formed with openings that extend through said bottom wall and wherein one opening is centrally positioned relative to each said cell of said plurality of cells.

6. The stackable tray device of claim 1, wherein said rib members of a cell each extend from a wall defining each said cell, said rib members extending from a said wall at a non-parallel angle to the wall from which the rib member extends.

7. The stackable tray device of claim 1, wherein rib members extending into each cell extend a radial distance of unequal measure.

8. The stackable tray device of claim 1, wherein each rib member is further structured with an inner edge that is oriented toward a center of the cell.

9. The stackable tray device of claim 8, wherein said inner edge of each said rib member is oriented at an angle relative to the wall from which said rib member extends radially.

10. The stackable tray device of claim 4, wherein said rib members of said cells extend in axial length from near said bottom wall to near a top edge of said upper section.

11. The stackable tray device of claim 1, wherein each said cell of said plurality of cells is further defined by at least two wall sections extending from an inner surface of said perimeter wall of said upper section.

12. The stackable tray device of claim 11, wherein at least some of said rib members extend from said wall sections toward a center of said cell.

13. The stackable tray device of claim 11, wherein at least some of said cells of said plurality of cells are further defined by an inner surface of said perimeter wall of said upper section.

14. The stackable tray device of claim 13, further comprising at least one rib member extending from said inner surface of said perimeter wall of said upper section and oriented toward a center of said cell.

15. The stackable tray device of claim 14, wherein a pair of rib members extend from said inner surface of said perimeter wall of said upper section and extend radially inwardly toward a center of the cell.

16. The stackable tray device of claim 15, further wherein a pair of rib members extends radially from each wall section defining the cell.

17. The stackable tray device of claim 1, wherein at least one of said rib members extends radially inwardly toward a center of a cell from a point of intersection between converging wall sections of said upper section.

18. A stackable tray device for holding a plurality of generally cylindrical objects in an upright orientation, the holding tray comprising:
an upper section having a perimeter wall defining an interior space and having a perimeter dimension;
a lower section having a perimeter wall with a perimeter dimension, the perimeter dimension of the lower section being unequal to the perimeter dimension of the upper section; and
a plurality of cells formed within said interior space of said upper section, each cell of said plurality of cells having a center and having at least one rib member extending radially inwardly toward said center of said cell to retain a generally cylindrical object within said cell.

19. The stackable tray device of claim 18, wherein each cell of said plurality of cells is defined by at least two wall sections, and each said rib member being structured to extend radially from said at least two wall sections, each said rib member further being structured with an inner edge oriented toward the center of the cell with which it is associated, said inner edge being positioned at an angle to said wall section from which said rib member extends.

20. A method of stacking tray devices, comprising:
providing at least two stackable tray devices, each stackable tray device being configured with an upper section having a perimeter wall, a lower section having a perimeter wall, wherein the perimeter dimension of the lower section is unequal to the perimeter dimension of the upper section, and a shoulder defined by and between the differential in perimeter dimension of said upper section and said lower section, and having an inner ledge formed in an interior space of said lower section;
positioning a first stackable tray device adjacent a second stackable tray device to align the inner ledge of one stackable tray device with the shoulder of the second stackable tray device; and
bringing said inner ledge of said one stackable tray device into registration with the shoulder of the second stackable tray device to provide a nesting arrangement of the first and second stackable tray devices.
